(19) United States
(12) Patent Application Publication
(10) Pub. No.: US 2026/0109282 A1
(43) Pub. Date: Apr. 23, 2026

(54) FIXING AND CLAMPING DEVICE FOR VEHICLE-MOUNTED DESK PLATE FIXED TO STEERING WHEEL

(71) Applicant: Qinglv Long, Dongguan City (CN)

(72) Inventor: Qinglv Long, Dongguan City (CN)

(21) Appl. No.: 19/001,389

(22) Filed: Dec. 24, 2024

(30) Foreign Application Priority Data
Oct. 17, 2024 (CN) 2024225066257

(51) Int. Cl. B60N 3/00

(52) U.S. Cl. CPC B60N 3/005

(57) ABSTRACT

Disclosed is a fixing and clamping device for a vehicle-mounted desk plate fixed to a steering wheel. The fixing and clamping device includes a base, and a left clamping arm and a right clamping arm which are slidably and detachably connected or fixedly connected to opposite sides of the base, where the left clamping arm and the right clamping arm have the same mirror image structure, the left clamping arm and the right clamping arm each include a clamping mechanism, and the clamping mechanism are detachably and rotationally connected to the left clamping arm and the right clamping arm respectively. Each clamping mechanism includes a clamping member arranged on the corresponding clamping mechanism, the clamping member is a C-shaped structural body or a non-closed semi-annular structural body, and the clamping member is used for being clamped on an annular grip rod of the steering wheel of a vehicle.

### CROSS REFERENCE TO RELATED APPLICATIONS

The present application claims the priority of Chinese patent application No. 2024225066257, filed on Oct. 17, 2024, and contents of which are incorporated herein by reference.

### TECHNICAL FIELD

The present disclosure relates to the technical field of vehicle-mounted accessories for vehicles, and in particular to a fixing and clamping device for a vehicle-mounted desk plate fixed to a steering wheel.

### BACKGROUND

With the continuous increase of people's demand for vehicle use functions, a vehicle-mounted desk plate is more and more widely used in vehicles. The vehicle-mounted desk plate provides a convenient table for passengers to work, eat or place articles, which improves a utilization rate of space in the vehicle and the comfort degree of the passengers. Especially a desk plate fixed on a steering wheel, when the vehicle stops, articles or notebook computers can be placed by a main driver, and the desk plate has the advantages of convenient use, etc., and is deeply loved by consumers.

At present, the types of steering wheels include circular steering wheels, D-shaped steering wheels, double-D-shaped steering wheels, polygonal steering wheels, half-spoke steering wheels, two-spoke steering wheels, three-spoke steering wheels, four-spoke steering wheels, etc., and width sizes of steering wheels of different models or brands are different. If left and right clamping arms and clamping mechanisms with fixed design are employed, generally, the width adjustment of the steering wheel and the angle adjustment of the clamping mechanism cannot be carried out. Mounting is very troublesome, and the stability of the mounted vehicle-mounted desk plate is poor in actual use. Further, the clamping mechanism is pressed by pressure during mounting, such that an outer surface of the steering wheel is pressed by edges and corners of the clamping mechanism, leather or rubber surface wrapped around the steering wheel surface is likely to be damaged and scratched, and the clamping mechanism cannot be disassembled for replacement or disassembled for storage. And therefore, a fixing and clamping device for a vehicle-mounted desk plate fixed to a steering wheel is provided.

### SUMMARY

An objective of the present disclosure is to provide a fixing and clamping device for a vehicle-mounted desk plate fixed to a steering wheel, aiming at solving the problems that an existing mechanism for connection and fixation has poor adaptability and troublesome mounting and fixation, and a clamping mechanism is unable to be quickly dismounted and mounted.

The present disclosure is implemented as follows: a fixing and clamping device for a vehicle-mounted desk plate fixed to a steering wheel includes a base, and a left clamping arm and a right clamping arm which are slidably and detachably connected or fixedly connected to opposite sides of the base, where the left clamping arm and the right clamping arm have the same mirror image structure, the left clamping arm and the right clamping arm each include a clamping mechanism, and the clamping mechanisms are detachably and rotationally connected to the left clamping arm and the right clamping arm respectively. Each clamping mechanism includes a clamping member arranged on the corresponding clamping mechanism, the clamping member is a C-shaped structural body or a non-closed semi-annular structural body, and the clamping member is used for being clamped on an annular grip rod of the steering wheel of a vehicle to form mounting and fixing of the base.

Further, the clamping mechanism further includes a shaft rod fixedly connected to one end of the clamping member, the end of the shaft rod is provided with a limiting table, and the limiting table is an annular structural body or a circular structural body or a convex structural body extending to any circumferential direction of the end of the shaft rod.

Further, the ends, opposite to the base, of the left clamping arm and the right clamping arm each are provided with a mounting table, and the clamping mechanisms are correspondingly arranged on the mounting platforms one by one.

Further, a rotating groove is provided inside each mounting table in a vertical direction, a shaft hole is provided in a center of each rotating groove in a horizontal direction, and the limiting table on each clamping mechanism is rotationally connected in the corresponding rotating groove through the corresponding shaft hole.

Further, the base at least includes two locking assemblies arranged inside the base, the two locking assemblies are arranged corresponding to the left clamping arm and the right clamping arm one by one, and the locking assemblies are used for locking and unlocking left and right sliding states of the left clamping arm and the right clamping arm.

The left clamping arm and the right clamping arm further include tooth patterns I arranged on surface portions of the left clamping arm and the right clamping arm.

Further, each locking assembly includes a key body and an elastic body arranged below the key body, tooth patterns II are arranged at the positions, corresponding to the tooth patterns I, of each key body, and the tooth patterns II are meshed with the tooth patterns I. A convex cylindrical key is arranged on an upper surface of the key body, and a groove is provided at a bottom surface of the key body. One end of each elastic body is positioned in the corresponding groove, and the other end of the elastic body is in contact with an inner wall of the base. The cylindrical key penetrates a corresponding base housing, and the key body elastically abuts against the elastic body to form a pressing reset effect on the key body.

Further, the clamping mechanism further includes a locking mechanism arranged inside the mounting table, and the locking mechanism is used for quick mounting and dismounting of the clamping mechanism.

Further, the locking mechanism includes a release key and a spring arranged at a bottom of the release key, one end of the spring is in contact with an inner wall of the mounting table, and the other end of the spring elastically abuts against the release key to form a press reset effect on the release key. A semi-annular groove with a certain depth is provided at the release key, the release key penetrates a corresponding housing of the mounting table and extends outwards out of the mounting table, and the release key is slidably connected in the mounting table up and down. A first limiting table on the clamping mechanism penetrates the corresponding housing of the mounting table and extends into the semi-annular groove in the release key, such that a locking state of the clamping member by the locking mechanism is formed to prevent the clamping mechanism from falling off. The release key is pressed, the spring is deformed and retracts, the semi-annular groove in the release key is separated from the first limiting table on the clamping mechanism, in this case, an unlocking state of the clamping mechanism by the locking mechanism is formed, and the clamping mechanism is capable of being quickly dismounted or mounted in this case.

Further, the locking mechanism includes a threaded rod fixedly arranged on the mounting table and a threaded cap in threaded connection to the threaded rod, and the threaded rod is provided with a mounting cavity in a middle. The end, close to the threaded rod, of the clamping member is fixedly connected to a second limiting table through a connecting rod, a passing hole is provided in the threaded cap, the second limiting table on the clamping mechanism penetrates the passing hole and extends to the mounting cavity in the threaded rod, and the clamping mechanism is locked and fixed by the threaded cap to prevent from falling off.

Further, the locking mechanism includes a shaft hole cavity provided at the mounting table and having two ends penetrating each other, and a third limiting table, one end of the shaft hole cavity is provided with a limiting groove, and the third limiting table is mounted in the limiting groove. A diameter of the limiting groove is larger than a diameter of the shaft hole cavity. One end of each clamping member is fixedly connected to a shaft rod, the shaft rod is inserted into the shaft hole cavity and is in butt with the third limiting table, and the third limiting table is fixedly connected to the shaft rod through a screw. A diameter of the third limiting table is larger than that of the shaft hole cavity, thereby forming limiting to the shaft rod, and preventing the clamping mechanism from falling off.

Compared with the prior art, the present disclosure has the beneficial effects as follows:

1. According to the present disclosure, the left clamping arm and the right clamping arm are arranged on opposite sides of the base, the left clamping arm and the right clamping arm each can be disassembled and rotationally connected to one clamping mechanism, and the clamping member on each clamping mechanism is clamped on an annular grip rod of the steering wheel of a vehicle, such that mounting and fixation are very simple. Moreover, the clamping mechanisms can rotate, and directions of the clamping members of the clamping mechanisms can be adjusted to adapt to more shapes and types of steering wheels, so as to increase the market applicability of the device.

2. The left clamping arm and the right clamping arm of the present disclosure are slidably and detachably connected to the base, such that a distance between the left clamping mechanism and the right clamping mechanism on the left clamping arm and the right clamping arm can be adjusted to achieve the stability after the vehicle-mounted desk plate is mounted and fixed, and more steering wheels with different sizes can be adapted.

3. According to the present disclosure, three embodiments for a connecting structure of the clamping mechanisms mounted on the left clamping arm and the right clamping arm are designed, the clamping mechanisms are rotationally connected to the base, such that when the clamping members are clamped on the steering wheel of the vehicle, edges and corners of the clamping members can be avoided from being attached to the steering wheel, abnormal compression on the steering wheel can be avoided, and damage to a rubber sleeve on the steering wheel can be avoided. Moreover, the directions of the clamping members can be conveniently adjusted according to the steering wheels with different shapes and structures, which is convenient for mounting and use. Further, by arranging three connecting mechanisms, the clamping members can be disassembled and replaced when being damaged, thereby improving the flexibility of use.

4. In Example 1 of the present disclosure, the orientations of the clamping members can be adjusted by pressing the release keys to release pressing on the first limiting tables, and the orientations of the clamping members can be fixed by releasing the release keys to reset, which is convenient for mounting and use. In Example 2, the orientations of the clamping members can be fixed by rotating the threaded caps to press the second limiting tables, and the threaded caps and the threaded rods can be disassembled to facilitate disassembly and assembly. In Example 3, the clamping mechanisms can be rotationally connected to the base through connection between the third limiting tables and the shaft rods, and the clamping mechanisms can be disassembled by disassembling the third limiting tables and the shaft rods, such that the clamping mechanisms can be conveniently replaced or stored as a whole.

In summary, through the mutual influence of the above multiple actions, it is convenient to adjust the mounting directions of the clamping members, and avoid the edges and corners of the clamping members from being attached to the steering wheel, thereby preventing from generating abnormal compression on the steering wheel. Moreover, it is convenient to disassemble, replace or store the clamping mechanisms 21, thereby improving the flexibility of use.

### BRIEF DESCRIPTION OF THE DRAWINGS

FIG. 1 is a diagram for a use state in which a base, a left clamping arm and a right clamping arm are mounted on a steering wheel of the present disclosure.

FIG. 2 is a schematic diagram of an integral structure of the present disclosure.

FIG. 3 is a cutaway view of a left clamping arm in the present disclosure.

FIG. 4 is a state diagram showing separation between a left clamping arm and a clamping mechanism in the present disclosure.

FIG. 5 is a schematic diagram of an internal structure of a base in the present disclosure.

FIG. 6 is a schematic diagram of an integral structure of the present disclosure.

FIG. 7 is a schematic structural diagram of a locking assembly in the present disclosure.

FIG. 8 is a schematic structural diagram of a key body in the present disclosure.

FIG. 9 is a schematic diagram of an integral structure of Example 1 of the present disclosure.

FIG. 10 is a schematic structural diagram from another view of Example 1 of the present disclosure.

FIG. 11 is a partially split schematic structural diagram of Example 1 of the present disclosure.

FIG. 12 is a partially enlarged schematic structural diagram of portion A in FIG. 11 of Example 1 of the present disclosure.

FIG. 13 is a schematic diagram of an integral structure of Example 2 of the present disclosure.

FIG. 14 is a schematic structural diagram from another view of Example 2 of the present disclosure.

FIG. 15 is a partially split schematic structural diagram of a base and a clamping member in Example 2 of the present disclosure.

FIG. 16 is a schematic diagram of an integral structure of Example 3 of the present disclosure.

FIG. 17 is a partially split schematic structural diagram of Example 3 of the present disclosure.

### DETAILED DESCRIPTIONS OF THE EMBODIMENTS

In the present disclosure, unless otherwise explicitly specified and defined, the terms “mounting”, “connecting”, “connection”, “fixing”, etc. should be understood in a broad sense, for example, they may denote fixed connection, detachable connection, or integrated connection, denote mechanical connection or electrical connection, denote direct connection or indirect connection via an intermediate medium, or denote communication between interiors of two elements or interaction between two elements. The specific meanings of the above terms in the present disclosure may be understood on a case-by-case basis for those of ordinary skill in the art.

A further specification is made below with reference to the accompanying drawings and in conjunction with particular examples:

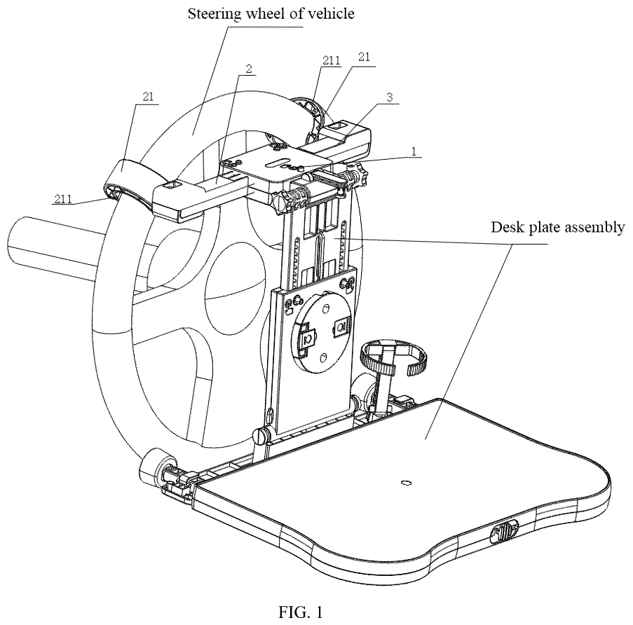

As shown in FIG. 1, a fixing and clamping device for a vehicle-mounted desk plate fixed to a steering wheel includes a base 1, and a left clamping arm 2 and a right clamping arm 3 which are slidably and detachably connected or fixedly connected to opposite sides of the base 1, where the left clamping arm 2 and the right clamping arm 3 have the same mirror image structure, the left clamping arm 2 and the right clamping arm 3 each include a clamping mechanism 21, and the clamping mechanisms are detachably and rotationally connected to the left clamping arm 2 and the right clamping arm 3 respectively. Each clamping mechanism 21 includes a clamping member 211 arranged on the corresponding clamping mechanism 21, the clamping member 211 is a C-shaped structural body or a non-closed semi-annular structural body, and the clamping member 211 is used for being clamped on an annular grip rod of the steering wheel of a vehicle to form mounting and fixing of the base 1.

Thus, the left clamping arm 2 and the right clamping arm 3 are arranged on opposite sides of the base 1, the left clamping arm 2 and the right clamping arm 3 each can be disassembled and rotationally connected to one clamping mechanism 21, and the clamping member 211 on each clamping mechanism 21 is clamped on the annular grip rod of the steering wheel of the vehicle, such that mounting and fixation are very simple. Moreover, the clamping mechanisms 21 can rotate, and orientations of the clamping members 211 of the clamping mechanisms 21 can be adjusted to adapt to more shapes and types of steering wheels, so as to increase the market applicability of the device.

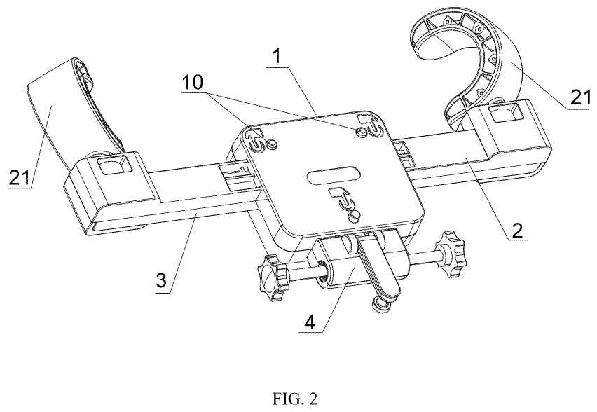

As shown in FIGS. 1 and 2, the base 1 is further provided with a desk plate connecting portion 4, and the desk plate connecting portion 4 is used for connecting the vehicle-mounted desk plate.

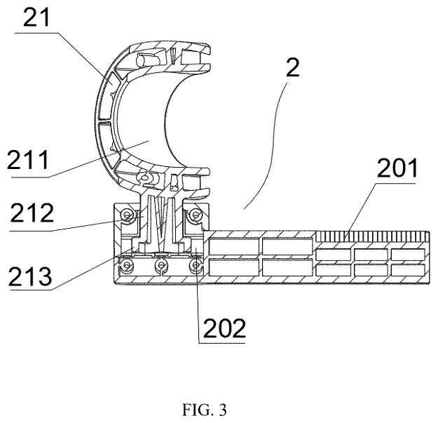

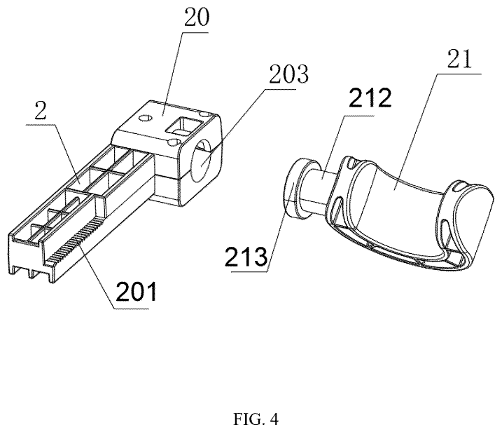

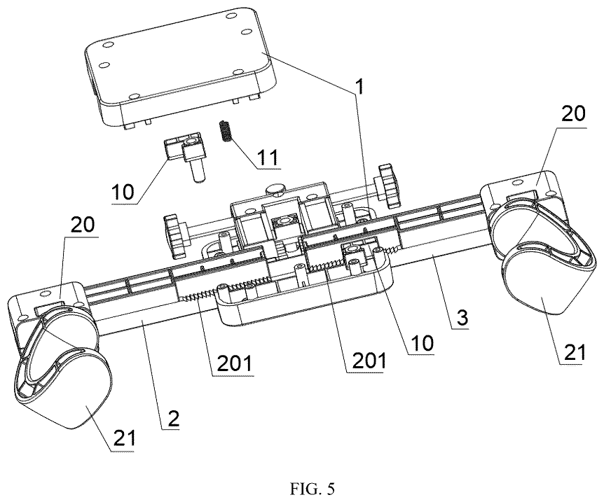

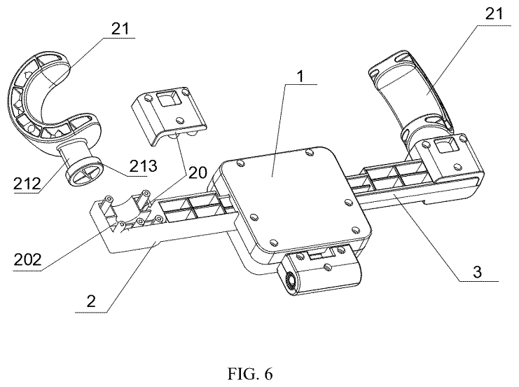

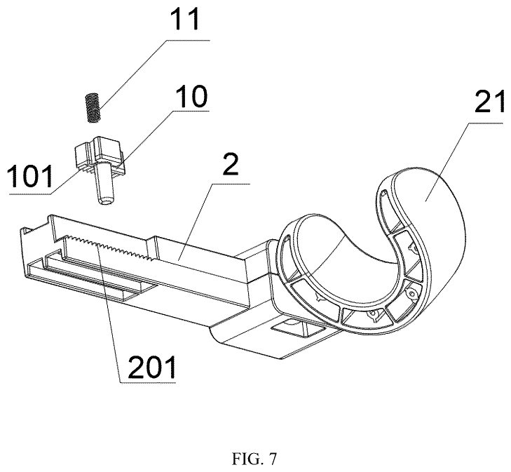

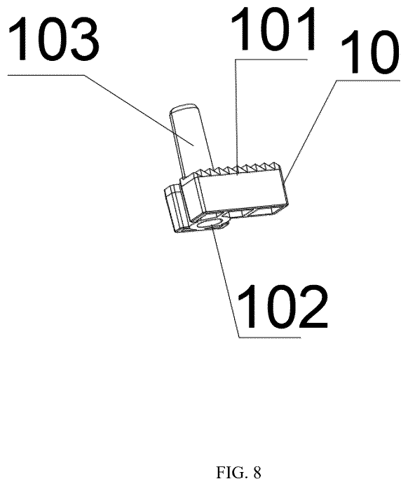

As shown in FIGS. 1-8, the clamping mechanism 21 further includes a shaft rod 212 fixedly connected to one end of the clamping member 211, the end of the shaft rod 212 is provided with a limiting table 213, and the limiting table 213 is an annular structural body or a circular structural body or a convex structural body extending to any circumferential direction of the end of the shaft rod 212. In the present disclosure, the limiting table 213 is set as a circular structural body. The end, opposite to the base 1, of the left clamping arm 2 is provided with a mounting table 20, and the mounting table 20 is used for mounting the clamping mechanism 21. A rotating groove 202 is provided inside the mounting table 20 in a vertical direction, and a shaft hole 203 is provided in a center of the rotating groove 202 in a horizontal direction. A diameter of the shaft hole 203 is smaller than that of the rotating groove 202, and a width of the limiting table 213 is larger than the diameter of the shaft hole 203 to prevent the clamping mechanism 21 from falling off. The limiting table 213 on the clamping mechanism 21 passes through the shaft hole 203 and is rotationally connected in the rotating groove 202.

As shown in FIGS. 1-8, the left clamping arm 2 further includes tooth patterns I 201 arranged on a surface portion of the left clamping arm 2. The base 1 at least includes two locking assemblies arranged inside the base 1, the two locking assemblies are arranged corresponding to the left clamping arm 2 and the right clamping arm 3 one by one, and the locking assemblies are used for locking and unlocking left and right sliding states of the left clamping arm 2 and the right clamping arm 3. The left clamping arm 2 and the right clamping arm 3 further include tooth patterns I arranged on surface portions of the left clamping arm 2 and the right clamping arm 3. Each locking assembly includes a key body 10 and an elastic body 11 arranged below the key body 10, and the key body 10 elastically abuts against the elastic body 11 so as to form a pressing rest effect on the key body 10. Tooth patterns II 101 are arranged at the positions, corresponding to the tooth patterns I 201, of the key body 10, and the tooth patterns II 101 are meshed with the tooth patterns I 201. A convex cylindrical key 103 is arranged on an upper surface of the key body 10, and a groove 102 is provided at a bottom surface of the key body 10. One end of the elastic body 11 is positioned in the groove 102, and the other end of the elastic body 11 is in contact with an inner wall of the base 1. The cylindrical key 103 penetrates a corresponding base 1 housing, and the elastic body 11 is of a spring or other structural body having certain flexibility and capable of rebounding for reset. The left clamping arm 2 and the right clamping arm 3 have the same mirror image structure.

Thus, when a user wants to adjust a distance between the left and right clamping mechanisms 21, the user only needs to press the key body 10 in the corresponding locking assembly, the key body 10 slides towards an interior of the base 1 under pressure, and the tooth patterns I 201 on the key body 10 are separated from the tooth patterns II 101 on the left clamping arm 2 or the right clamping arm 3. The left clamping arm 2 or the right clamping arm 3 is in an unlocked state in this case, and the distance between the clamping mechanisms 21 can be adjusted by pushing or pulling the left clamping arm 2 or the right clamping arm 3 inwards, operation is very convenient.

To sum up, in the present disclosure, the left clamping arm 2 and the right clamping arm 3 are slidably and detachably connected to the base 1, such that the distance between the left and right clamping mechanisms 21 on the left clamping arm 2 and the right clamping arm 3 can be adjusted to achieve the stability after the vehicle-mounted desk plate is mounted and fixed, and more steering wheels with different sizes can be adapted.

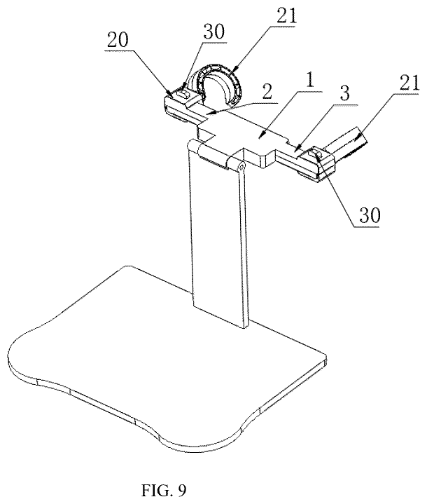

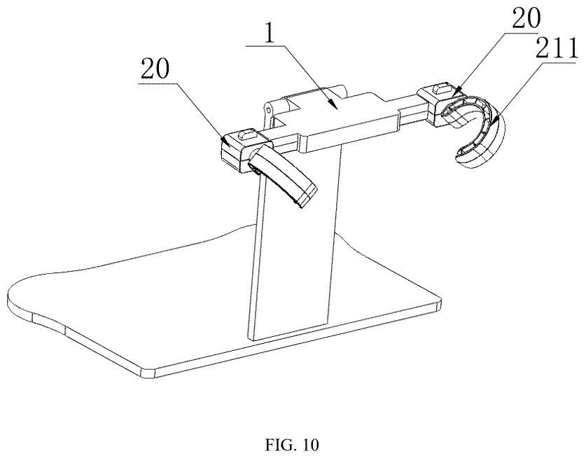

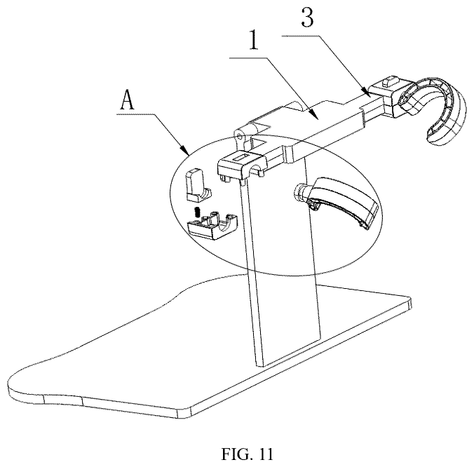

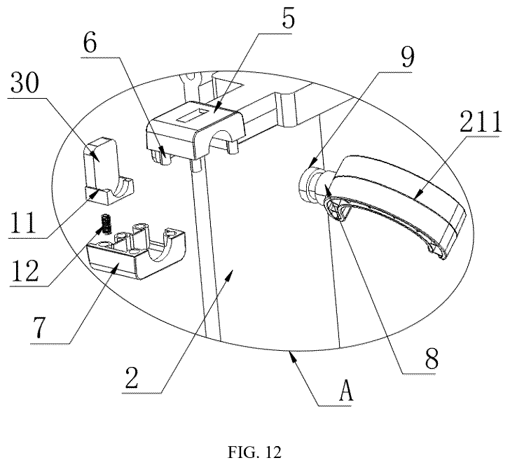

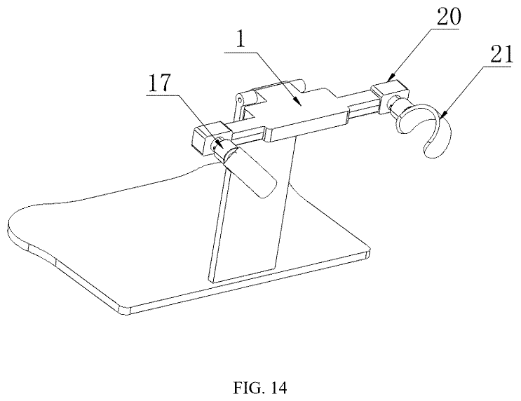

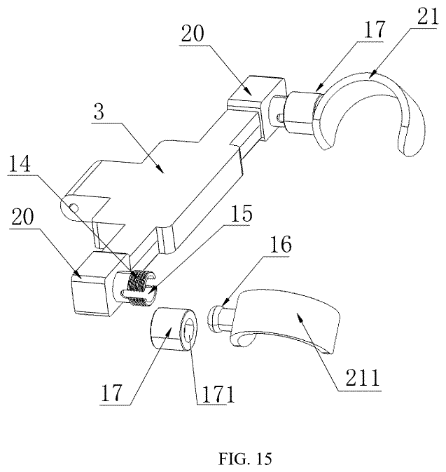

As shown in FIGS. 9-17, a connecting structure between the clamping mechanisms 21 and the left clamping arm 2 and the right clamping arm 3 is described in the following three examples.

The clamping mechanism 21 further includes a locking mechanism arranged inside the mounting table 20, and the locking mechanism is used for quick mounting and dismounting of the clamping member.

### Example 1

In a fixing and clamping device for a vehicle-mounted desk plate fixed to a steering wheel shown in FIGS. 9-12, a locking mechanism includes a release key 30 inside a mounting table 20 and a spring 12 arranged at a bottom of the release key 30, the mounting table 20 includes a bottom housing 6 and a surface housing 7 fixedly connected to a left clamping arm 2 and a right clamping arm 3. The surface housing 7 is fixed to a bottom of the bottom housing 6 through a screw. One end of the spring 12 is in contact with an inner wall of the mounting table 20, and the other end of the spring 12 elastically abuts against the release key 30 to form a press reset effect on the release key 30. A shaft rod 8 and a first limiting table 9 fixedly connected to the shaft rod 8 are arranged on the clamping mechanism 21, and the first limiting table 9 is arranged opposite the clamping mechanism 21. The release key 30 is an L-shaped structural body as a whole, and a semi-annular groove 11 with a certain depth is provided at the release key 30. The release key 30 penetrates the corresponding housing of the mounting table 20 and extends outwards out of the mounting table 20, and the release key 30 is slidably connected in the mounting table 20 up and down. The first limiting table 9 on the clamping mechanism 21 penetrates the corresponding housing of the mounting table 20 and extends into the semi-annular groove 11 in the release key 30. When the first limiting table 9 is located in the semi-annular groove 11 in the release key 30, a locking state of the clamping member 211 by the locking mechanism is formed to prevent the clamping mechanism 21 from falling off. The release key 30 is pressed, the spring 12 is deformed and retracts, the semi-annular groove 11 in the release key 30 is separated from the first limiting table 9 on the clamping member 211, in this case, an unlocking state of the clamping mechanism 21 by the locking mechanism is formed, and the clamping mechanism 21 is capable of being quickly dismounted or mounted in this case.

### Example 2

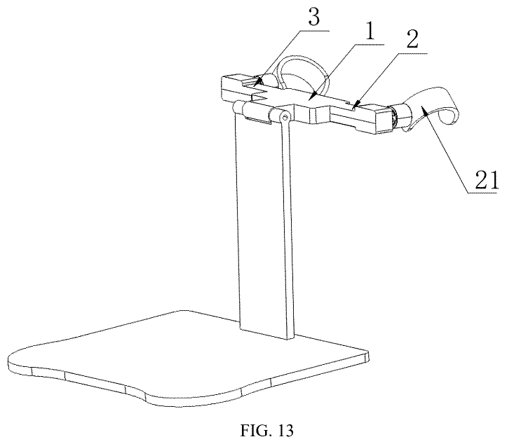

A fixing and clamping device for a vehicle-mounted desk platefixed to a steering wheels is as shown in FIGS. 13-15.

The locking mechanism includes a threaded rod 14 fixedly arranged on the mounting table 20 and a threaded cap 17 in threaded connection to the threaded rod 14, where the threaded rod 14 is provided with a mounting cavity 15 in a middle. The end, close to the threaded rod 14, of the clamping member 211 is fixedly connected to a second limiting table 16 through a connecting rod, and a passing hole 171 is provided in the threaded cap 17. The second limiting table 16 on the clamping mechanism 21 penetrates the passing hole 171 and extends to the mounting cavity 15 in the threaded rod 14, and the clamping mechanism 21 is locked and fixed by the threaded cap 17. In this example, avoidance openings are provided in opposite sides of the threaded rod 14, and an internal aperture of the threaded cap 17 is of a structural body with a large front end and gradually reduced rear end. When the threaded cap 17 is gradually tightened, an interior of the threaded cap 17 presses the threaded rod 14, such that the avoidance openings in the threaded rod 14 are deformed, thereby reducing an opening, located at the front end of the threaded rod 14, of the mounting cavity 15, so as to prevent the clamping mechanism 21 from falling off. Meanwhile, the clamping mechanism 21 is also fixed, which is convenient for later disassembly, storage and assembly of the clamping mechanism 21.

### Example 3

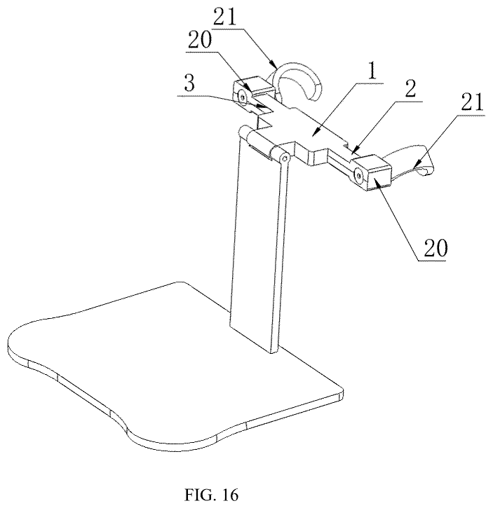

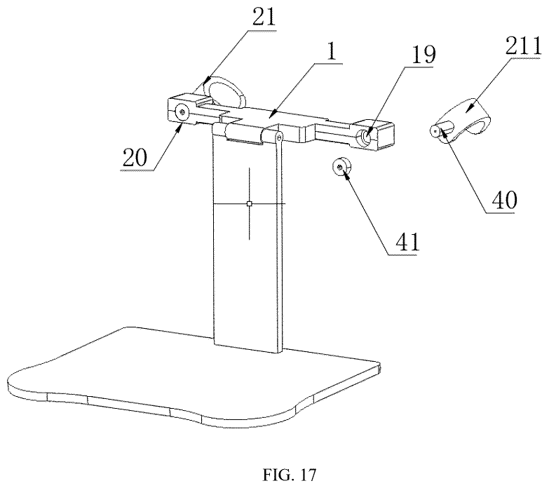

A fixing and clamping device for a vehicle-mounted desk plate fixed to a steering wheel is as shown in FIGS. 16 and 17. The locking mechanism includes a shaft hole cavity provided at the mounting table 20 and having two ends penetrating each other, and a third limiting table 41. One end of the shaft hole cavity is provided with a limiting groove 19, the third limiting table 41 is mounted in the limiting groove 19, and a diameter of the limiting groove 19 is larger than a diameter of the shaft hole cavity. One end of the clamping member 211 is fixedly connected to a shaft rod 40, the shaft rod 40 is inserted into the shaft hole cavity and is in butt with the third limiting table 41, and the third limiting table 41 is fixedly connected to the shaft rod 40 through a screw. A diameter of the third limiting table 41 is larger than that of the shaft hole cavity, thereby forming limiting to the shaft rod 40, and preventing the clamping mechanism 21 from falling off. Moreover, the clamping mechanism 21 can rotate, such that an orientation and an angle of the clamping member 211 can be conveniently adjusted.

Working principle of the present disclosure: in the technical solution, three embodiments are designed for a connecting structure of a mounting hook of the vehicle-mounted desk plate, and the base 1 is mounted and fixed by clamping the clamping member 211 on the annular grip rod of the steering wheel of the vehicle.

According to the design of the locking mechanism in Example 1, the clamping member 211 can be conveniently loosened and fixed by pressing the release key 30 to press the spring 12, the clamping member 211 can conveniently rotate, the orientation of the clamping member 211 can be conveniently adjusted, and the clamping member 211 can also be conveniently mounted and dismounted quickly. By loosening the release key 30, the angle orientation of the clamping member 211 can be fixed along with the push of the release key 30 through reset of the spring 12, which facilitates auxiliary mounting and use.

According to the design of the locking mechanism in Example 2, the clamping mechanism 21 is conveniently separated from the mounting table 20 by rotating the threaded cap 17. Moreover, the threaded cap 17 is rotated to be connected to the threaded rod 14. Compressive strength to the second limiting table 16 can be adjusted by rotating the threaded cap 17, such that the angle orientation of the clamping member 211 can be conveniently fixed, the auxiliary mounting and use are facilitated, and the clamping mechanism 21 can also be prevented from falling off.

The locking mechanism in Example 3 has a simple design structure. The cylindrical shaft rod 40 and the third limiting table 41 are fixedly connected by the screw, and the clamping mechanism 21 is rapidly rotated and mounted on the mounting table 20. Moreover, the clamping mechanism 21 can rotate flexibly, and the clamping mechanism 21 can be prevented from falling off.

The foregoing are merely the preferred embodiments of the present disclosure and are not intended to limit the present disclosure, and various modifications and changes may be made by those skilled in the art. Any modifications, equivalent replacements, improvements, etc. made within the spirit and principles of the present disclosure should fall within the scope of protection of the present disclosure.

What is claimed is:

1. A fixing and clamping device for a vehicle-mounted desk plate fixed to a steering wheel, comprising a base, and a left clamping arm and a right clamping arm which are slidably and detachably connected or fixedly connected to opposite sides of the base, wherein the left clamping arm and the right clamping arm have the same mirror image structure, the left clamping arm and the right clamping arm each comprise a clamping mechanism, the clamping mechanisms are detachably and rotationally connected to the left clamping arm and the right clamping arm respectively, each clamping mechanism comprises a clamping member arranged on the corresponding clamping mechanism, the clamping member is a C-shaped structural body or a non-closed semi-annular structural body, and the clamping member is used for being clamped on an annular grip rod of the steering wheel of a vehicle to form mounting and fixing of the base.

2. The fixing and clamping device for a vehicle-mounted desk plate fixed to a steering wheel according to claim 1, wherein the clamping mechanism further comprises a shaft rod fixedly connected to one end of the clamping member, the end of the shaft rod is provided with a limiting table, and the limiting table is an annular structural body or a circular structural body or a convex structural body extending to any circumferential direction of the end of the shaft rod.

3. The fixing and clamping device for a vehicle-mounted desk plate fixed to a steering wheel according to claim 1, wherein the ends, opposite to the base, of the left clamping arm and the right clamping arm each are provided with a mounting table, and the clamping mechanisms are correspondingly arranged on the mounting platforms one by one.

4. The fixing and clamping device for a vehicle-mounted desk plate fixed to a steering wheel according to claim 3, wherein a rotating groove is provided inside each mounting table in a vertical direction, a shaft hole is provided in a center of each rotating groove in a horizontal direction, and the limiting table on each clamping mechanism is rotationally connected in the corresponding rotating groove through the corresponding shaft hole.

5. The fixing and clamping device for a vehicle-mounted desk plate fixed to a steering wheel according to claim 1, wherein the base at least comprises two locking assemblies arranged inside the base, the two locking assemblies are arranged corresponding to the left clamping arm and the right clamping arm one by one, and the locking assemblies are used for locking and unlocking left and right sliding states of the left clamping arm and the right clamping arm; and
the left clamping arm and the right clamping arm further comprise tooth patterns I arranged on surface portions of the left clamping arm and the right clamping arm.

6. The fixing and clamping device for a vehicle-mounted desk plate fixed to a steering wheel according to claim 5, wherein each locking assembly comprises a key body and an elastic body arranged below the key body, tooth patterns II are arranged at the positions, corresponding to the tooth patterns I, of each key body, the tooth patterns II are meshed with the tooth patterns I, a convex cylindrical key is arranged on an upper surface of the key body, a groove is provided at a bottom surface of the key body, one end of each elastic body is positioned in the corresponding groove, the other end of the elastic body is in contact with an inner wall of the base, the cylindrical key penetrates a corresponding base housing, and the key body elastically abuts against the elastic body to form a pressing reset effect on the key body.

7. The fixing and clamping device for a vehicle-mounted desk plate fixed to a steering wheel according to claim 1, wherein the clamping mechanism further comprises a locking mechanism arranged inside the mounting table, and the locking mechanism is used for quick mounting and dismounting of the clamping mechanism.

8. The fixing and clamping device for a vehicle-mounted desk plate fixed to a steering wheel according to claim 7, wherein the locking mechanism comprises a release key and a spring arranged at a bottom of the release key, one end of the spring is in contact with an inner wall of the mounting table, the other end of the spring elastically abuts against the release key to form a press reset effect on the release key, a semi-annular groove with a certain depth is provided at the release key, the release key penetrates a corresponding housing of the mounting table and extends outwards out of the mounting table, the release key is slidably connected in the mounting table up and down, a first limiting table on the clamping member penetrates the corresponding housing of the mounting table and extends into the semi-annular groove in the release key, such that a locking state of the clamping mechanism by the locking mechanism is formed to prevent the clamping mechanism from falling off, the release key is pressed, the spring is deformed and retracts, the semi-annular groove in the release key is separated from the first limiting table on the clamping mechanism, in this case, an unlocking state of the clamping mechanism by the locking mechanism is formed, and the clamping mechanism is capable of being quickly dismounted or mounted in this case.

9. The fixing and clamping device for a vehicle-mounted desk plate fixed to a steering wheel according to claim 7, wherein the locking mechanism comprises a threaded rod fixedly arranged on the mounting table and a threaded cap in threaded connection to the threaded rod, the threaded rod is provided with a mounting cavity in a middle, the end, close to the threaded rod, of the clamping member is fixedly connected to a second limiting table through a connecting rod, a passing hole is provided in the threaded cap, the second limiting table on the clamping mechanism penetrates the passing hole and extends to the mounting cavity in the threaded rod, and the clamping mechanism is locked and fixed by the threaded cap to prevent from falling off.

10. The fixing and clamping device for a vehicle-mounted desk plate fixed to a steering wheel according to claim 7, wherein the locking mechanism comprises a shaft hole cavity provided at the mounting table and having two ends penetrating each other, and a third limiting table, one end of the shaft hole cavity is provided with a limiting groove, the third limiting table is mounted in the limiting groove, a diameter of the limiting groove is larger than a diameter of the shaft hole cavity, one end of the clamping member is fixedly connected to a shaft rod, the shaft rod is inserted into the shaft hole cavity and is in butt with the third limiting table, the third limiting table is fixedly connected to the shaft rod through a screw, and a diameter of the third limiting table is larger than that of the shaft hole cavity, thereby forming limiting to the shaft rod, and preventing the clamping mechanism from falling off.
